(19) United States
(12) Patent Application Publication
(10) Pub. No.: US 2015/0049749 A1
(43) Pub. Date: Feb. 19, 2015

(54) TRUST INDICATION FOR WLAN ACCESS NETWORKS

(71) Applicant: NOKIA SOLUTIONS AND NETWORKS OY, Espoo, OT (FI)

(72) Inventors: Anders Jan Olof Kall, Espoo (FI); Gyorgy Tamas Wolfner, Budapest (HU); Jouni Korhonen, Riihimaki (FI)

(73) Assignee: NOKIA SOLUTIONS AND NETWORKS OY, Espoo (FI)

(21) Appl. No.: 14/387,089

(22) PCT Filed: Mar. 21, 2013
(86) PCT No.: PCT/EP2013/055870

§ 371 Date: Sep. 22, 2014

Related U.S. Application Data
(60) Provisional application No. 61/614,763, filed on Mar. 23, 2012.

(51) Int. Cl. H04W 12/08; H04W 48/16

(52) U.S. Cl. CPC H04W 12/08; H04W 48/16; H04W 84/12
USPC 370/338

(57) ABSTRACT

It is provided a method, comprising providing a non 3GPP network access to a user equipment (S10); connecting an apparatus performing the method via an interface to a packet data network gateway of a packet core network (S20); indicating, to the packet data network gateway via the interface, an indication whether the non 3GPP network access is a trusted access (S30).

### FIELD OF THE INVENTION

The present invention relates to an apparatus, a method, a system, and a computer program product related to improving the access from non-3GPP access networks to the 3GPP network. More particularly, the present invention relates to an apparatus, a method, a system, and a computer program product for improved access from a trusted non-3GPP network to the packet data core of the 3GPP network.

### BACKGROUND OF THE INVENTION

### Abbreviations

| | |
|---|---|
| 3GPP | 3rd generation partnership project |
| TWAN | Trusted WLAN Access Network |
| WLAN | Wireless local area network |
| APCO | Additional Protocol Configuration Options |
| PCO | Protocol Configuration Options |
| MAG | Mobility Access gateway |
| PBU | Proxy Binding Update |
| PBA | Proxy Binding Acknowledgment |
| LMA | Local Mobility Anchor |
| PDN-GW | Packet data network gateway |
| AVP | Attribute value pair |
| PMIP | Proxy mobile IP |
| IP | Internet protocol |
| GTP | GPRS tunneling protocol |
| GPRS | General packet radio service |
| RA | Router advertisement |
| RAT | Radio access technology |
| TS | Technical specification |
| AAA | Authentication, authorization, and accounting |
| EPC | Evolved packet core |
| CDR | Charging data record |
| IANA | Internet assigned numbers authority |
| CR | Change Request |
| ePDG | evolved Packet Data Gateway |

The present application is related to the authentication in 3GPP networks of subscribers attaching to a trusted WLAN network. More specifically, it improves the solution specified for Trusted WLAN Access without UE impact (SaMOG_wlan) according to section 16 of 3GPP TS 23.402 Release 11.

FIG. 1 shows an example of an architecture for such trusted WLAN access, as specified by 3GPP TS 23.402, v11.2.0. According to this architecture, the trusted WLAN access network is connected to the 3GPP AAA server via STa interface and to the 3GPP PDN gateway via S2a interface. According to this TS, the S2a interface supports two protocol variants: GTP and PMIP v6 to be chosen by the TWAN.

The trust relationship of the access network is not a technical aspect of the access network but a decision of the operator of the network, which e.g. determines the authentication method to be used for network access. When the UE is attaching to a Trusted WLAN Access Network (TWAN) the UE shall first be authenticated and connection authorized by the 3GPP AAA Server, which is informed by TWAN about the trust relationship of the access network as currently specified by 3GPP.

It is an object of the present invention to improve the prior art.

According to a first aspect of the invention, there is provided an apparatus, comprising access providing means adapted to provide a non 3GPP network access to a user equipment; connecting means adapted to connect the apparatus via an interface to a packet data network gateway of a packet core network; indicating means adapted to indicate, to the packet data network gateway via the interface, an indication whether the non 3GPP network access is a trusted access.

In the apparatus, the non 3GPP network access may be a wireless local area network access. In the apparatus, the packet core network and/or the user equipment may belong to a 3GPP network.

The apparatus may further comprise an AAA interface means adapted to interface with an authentication, and/or authorization, and/or accounting server of the 3GPP network.

In the apparatus, the indication may comprise a radio access technology type indicating whether the non 3GPP network access is a trusted access.

In the apparatus, the indication may comprise an information element dedicated to indicating whether the non 3GPP network access is trusted.

In the apparatus, the indication may be comprised in an additional protocol configuration option.

According to a second aspect of the invention, there is provided an apparatus, comprising access providing processor adapted to provide a non 3GPP network access to a user equipment; connecting processor adapted to connect the apparatus via an interface to a packet data network gateway of a packet core network; indicating processor adapted to indicate, to the packet data network gateway via the interface, an indication whether the non 3GPP network access is a trusted access.

In the apparatus, the non 3GPP network access may be a wireless local area network access. In the apparatus, the packet core network and/or the user equipment may belong to a 3GPP network.

The apparatus may further comprise an AAA interface processor adapted to interface with an authentication, and/or authorization, and/or accounting server of the 3GPP network.

In the apparatus, the indication may comprise a radio access technology type indicating whether the non 3GPP network access is a trusted access.

In the apparatus, the indication may comprise an information element dedicated to indicating whether the non 3GPP network access is trusted. In the apparatus, the indication may be comprised in an additional protocol configuration option.

According to a third aspect of the invention, there is provided an apparatus, comprising gateway means adapted to provide a packet data network gateway functionality of a packet core network; connecting means adapted to connect the apparatus via an interface to a non 3GPP access network; receiving means adapted to receive an indication from the non 3GPP network indicating whether the non 3GPP network is trusted.

In the apparatus, the non 3GPP access network may be a wireless local area network. In the apparatus, the packet core network may belong to a 3GPP network.

In the apparatus, the indication may comprise a radio access technology type indicating whether the non 3GPP access network is trusted.

In the apparatus, the indication may comprise an information element dedicated to indicating whether the non 3GPP access network is trusted.

In the apparatus, the indication may be comprised in an additional protocol configuration option.

The apparatus may further comprise charging data generating means adapted to generate charging data for a user device connected to the non 3GPP access network, wherein the charging data comprise a trust indication based on the received indication.

According to a fourth aspect of the invention, there is provided an apparatus, comprising gateway processor adapted to provide a packet data network gateway functionality of a packet core network; connecting processor adapted to connect the apparatus via an interface to a non 3GPP access network; receiving processor adapted to receive an indication from the non 3GPP network indicating whether the non 3GPP network is trusted.

In the apparatus, the non 3GPP access network may be a wireless local area network. In the apparatus, the packet core network may belong to a 3GPP network.

In the apparatus, the indication may comprise a radio access technology type indicating whether the non 3GPP access network is trusted.

In the apparatus, the indication may comprise an information element dedicated to indicating whether the non 3GPP access network is trusted.

In the apparatus, the indication may be comprised in an additional protocol configuration option.

The apparatus may further comprise charging data generating processor adapted to generate charging data for a user device connected to the non 3GPP access network, wherein the charging data comprise a trust indication based on the received indication.

According to a fifth aspect of the invention, there is provided a method, comprising providing a non 3GPP network access to a user equipment; connecting an apparatus performing the method via an interface to a packet data network gateway of a packet core network; indicating, to the packet data network gateway via the interface, an indication whether the non 3GPP network access is a trusted access.

In the method, the non 3GPP network access may be a wireless local area network access. In the method, the packet core network and/or the user equipment may belong to a 3GPP network.

The method may further comprise interfacing with an authentication, and/or authorization, and/or accounting server of the 3GPP network.

In the method, the indication may comprise a radio access technology type indicating whether the non 3GPP network access is a trusted access.

In the method, the indication may comprise an information element dedicated to indicating whether the non 3GPP network access is trusted.

In the method, the indication may be comprised in an additional protocol configuration option.

According to a sixth aspect of the invention, there is provided a method, comprising providing a packet data network gateway functionality of a packet core network; connecting an apparatus performing the method via an interface to a non 3GPP access network; receiving an indication from the non 3GPP network indicating whether the non 3GPP network is trusted.

In the method, the non 3GPP access network may be a wireless local area network. In the method, the packet core network may belong to a 3GPP network.

The method may further comprise selecting means adapted to select an IPv6 router advertisement message if the non 3GPP access network is trusted.

In the method, the indication may comprise a radio access technology type indicating whether the non 3GPP access network is trusted.

In the method, the indication may comprise an information element dedicated to indicating whether the non 3GPP access network is trusted.

In the method, the indication may be comprised in an additional protocol configuration option.

The method may further comprise generating charging data for a user device connected to the non 3GPP access network, wherein the charging data comprise a trust indication based on the received indication.

Each of the methods of the fifth and sixth aspects may be a method of trust indication.

According to a seventh aspect of the invention, there is provided a computer program product including a program comprising software code portions being arranged, when run on a processor of an apparatus, to perform the method according to any one of the fifth and sixth aspects.

The computer program product may comprise a computer-readable medium on which the software code portions are stored, and/or the program may be directly loadable into a memory of the processor.

According to embodiments of the invention, at least the following advantages are achieved:

The behavior of the PDN-GW may be different depending on whether the non-3GPP access network (such as WLAN) is trusted or not. In particular, based on this knowledge, it may decide whether or not to send IPv6 Router Advertisement messages or adapt its charging when the PDN-GW creates CDRs.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows the architecture for trusted WLAN access to EPC (taken from 3GPP TS 23.402, v11.2.0);

FIG. 2 shows an apparatus according to an embodiment of the invention;

FIG. 3 shows a method according to an embodiment of the invention.

FIG. 4 shows an apparatus according to an embodiment of the invention; and

FIG. 5 shows a method according to an embodiment of the invention.

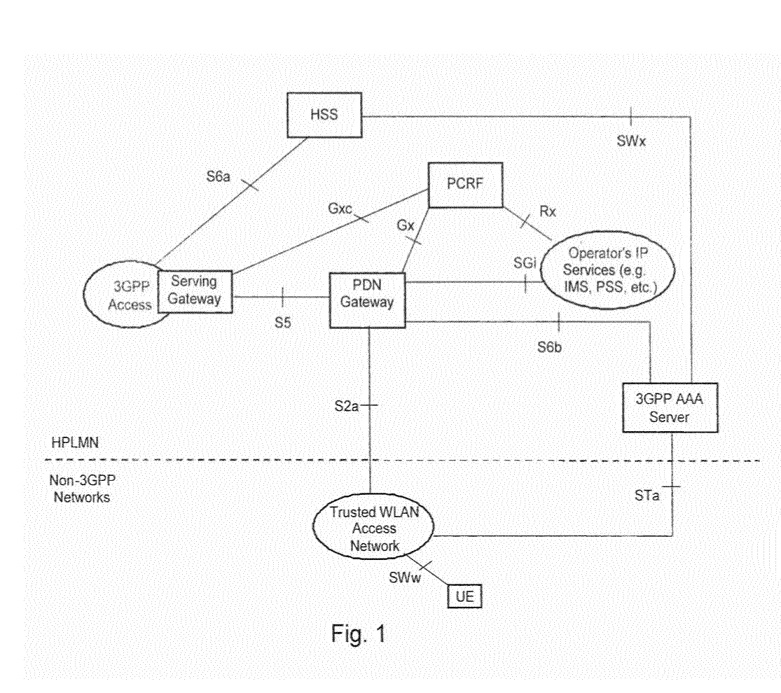

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

According to embodiments of the invention, the TWAN also informs the PDN-GW about the trust relationship of the WLAN access network in addition to informing the AAA server). This functionality is preferably applicable for the case when a WLAN is used as trusted access network. Conventionally, such an information flow over the S2a interface between TWAN and PDN-GW is not foreseen.

According to embodiments of the invention, the PDN-GW should learn whether the PDN connection to be set up is from a Trusted WLAN, because the PDN-GW behaviour (e.g. whether to send IPv6 RA messages) depends on whether the access network is a Trusted or or an Untrusted WLAN. The information about the type of the access network is also needed for other (e.g. charging) purposes when the PDN-GW creates a Charging Data Record (CDR).

For example, in some embodiments, CDRs generated by the PDN-GW may comprise a trust indication. An exemplary use case may be the following: An operator offers different tariffs if the UE connects via a Trusted WLAN Access Network (TWAN) or via Untrusted access, e.g. (possibly the same) WLAN but via ePDG. The informed UE (user) can select to connect via the cheaper TWAN by selecting and indicating the corresponding SSID. When the access network (gateway) is trusted, the UE can be directly connected to the PDN-GW (no need for a tunnel).

If TWAN is not available, if the UE is not authorized to use TWAN, or if UE decides for other reasons not to use TWAN, the UE may use untrusted access. When the UE is attached to an Untrusted access network, there cannot be any direct and open connection between the UE and the PDN-GW. Instead, the UE must first connect to an ePDG (which is trusted by the PDN-GW operator) and establish a secured tunnel between the UE and the ePDG, which then carries the traffic between the UE and PDN-GW (i.e. tunneling UE <-WLAN->ePDG-PDN-GW). This may be more expensive in than access via TWAN. The higher price may be justified because of the additional costs for the ePDG network element and more complex network configuration, operation and maintenance, in particular if the WLAN/ePDG belongs to a (potentially non-preferred) roaming partner. According to embodiments of the invention, the TWAN may inform the PDN-GW about the trust relationship of the access network using at least one of the solutions described below.

Solution A: a new RAT (Radio Access Technology) Type AVP “Trusted WLAN” is introduced in the S2a signaling between TWAN and PDN-GW. This new AVP may be used in S2a PMIP and/or S2a GTP signaling between TWAN and PDN-GW.

Solution B: a new indication is introduced to indicate that “the access network is trusted” or that “the access network is untrusted” in the S2a PMIP and GTP signaling between the TWAN and PDN-GW.

Solution C: the trust relationship indication is sent using the Information Element “Additional Protocol Configuration Option” (APCO) in the GTP and/or PMIP signaling between TWAN and PDN-GW.

Note that typically only one of the solutions A, B, and C is implemented.

The following implementation descriptions and possible specification changes are examples to help the understanding of embodiments of the invention. However, the solutions A and B may be implemented also in some other way in GTP and PMIP signalling. E.g., one additional possibility is sending the trust relationship indication in the Information Element “Additional Protocol Configuration Option” (APCO) which applies as such both to GTP and PMIP.

Embodiments according to solution A introduce a new RAT Type “Trusted WLAN”. From standardization point of view, this might be a quite straightforward solution, but there may be some logical inconsistency because the RAT Type should actually indicate the access network technology, not some other aspects of the access network. Potentially, backward compatibility issues with the existing RAT Type “WLAN” in solution A shown in the table taken from TS 29.212 shown below may have to be solved for commercial rollout.

An advantage of solution A is that the new RAT Type can also be used over other (e.g. Diameter based charging) interfaces where the used Access network type is needed: TWAN may send the RAT Type to the AAA server and the RAT Type may indicate “Trusted WLAN” if solution A is used. The AAA server, however, does not send any RAT Type AVP back to the TWAN, instead there is already a Trust Relationship Indication AVP in Diameter specified by 3GPP to be sent from the 3GPP AAA Server to TWAN, which may indicate “Trusted” in embodiments where solution A is implemented.

Solution B might be better from consistency and backward compatibility point of view, because the RAT Type can be kept as “WLAN” and the trust relationship indication is provided separately, orthogonal, from the access technology type. Solution B is also more flexible because the new trust relationship indication can be used for any access network technology and RAT type (e.g. in case of CDMA networks).

Solution C using APCO for trust relationship indication is rather demanding to be implemented in 3GPP specifications, because currently the contents of APCO is aligned with the contents of PCO (Protocol Configuration Options), which is specified in the basic 3GPP TS 24.008 specification. If a trust relationship indication in PCO is added, one has to take into account that the PCO contents shall be exchanged between the UE and the network but such usage of the trust indication is not foreseen. On the other hand, if the trust indication is introduced in APCO only, it would mean that the content of APCO deviates from the content of PCO and such an approach is not desirable.

### Example Implementation of Solution a

An implementation example of solution A (introducing a new RAT Type “Trusted WLAN” within the Information Element “Access Technology Type option”) is described in the form of a Change Request to 3GPP TS 29.275 and TS 29.212 below, where the additions are shown by underlining the new text. The new information is added to the Proxy Binding Update (PBU) message sent by TWAN to PDN-GW when the connection is first established. This Information Element also needs to be carried in the GTPv2 signalling between TWAN and PDN-GW, see the TS 29.212 table further down.

The Mobility Options in a PBU message for the PMIPv6 PDN Connection Creation procedure are depicted in 3GPP TS 29.275, Table 5.1.1.1-2, shown with underlined new text and highlighted relevant parts in the table and in the corresponding footnote.

TABLE 5.1.1.1-2
Mobility Options in a PBU message for the PMIPv6 PDN
Connection Creation procedure

| Information element | Cat. | IE Description | Reference |
|---|---|---|---|
| Mobile Node Identifier | M | Set to the NAI identifier of the UE as specified in 3GPP | 3GPP TS 23.003 [12] |
| option | | TS 23.003 [12]. The format of the NAI is specified in the | |
| | | subclause 19.3 in 3GPP TS 23.003 [12]. | |
| . . . | | | |
| [Other IEs not shown | | | |
| here] | | | |
| Access Technology | M | Set to the 3GPP access type, i.e. GERAN, UTRAN or | IETF RFC 5213 [4] |
| Type option | | E-UTRAN, or to the value matching the characteristics | |
| | | of the non-3GPP access (e.g., HRPD Trusted WLAN) | |
| | | the UE is using to attach to the EPS as defined in the | |
| | | Access Technology Type Option type values | |
| | | registry of the IANA Mobile IPv6 Parameters | |
| | | Registry [18]. *) | |
| | | The ePDG may use the access technology type of the | |
| | | untrusted non-3GPP access network if it is able to | |
| | | acquire it; otherwise it shall indicate Virtual as the | |
| | | access technology. | |
| | | NOTE 2. | |
| | | NOTE 3. | |
| . . . | | | |

NOTE 1: . . .
NOTE 2: The methods that the ePDG may use to acquire the access technology type of the untrusted non-3GPP IP access network are not specified in this release.
NOTE 3: The PDN-GW can be informed about the type of access network used by the UE over several reference points, see 3GPP TS 29.212 [30] for the mapping between the code values for the different access network types.
NOTE 4: . . .
*) According to solution A of embodiments of this invention, the new RAT Type “Trusted WLAN” also needs to be added to the IANA Mobile IPv6 Parameters Registry.

The implementation of solution A to introduce the new RAT Type “Trusted WLAN” may also be specified in the form of a Change Request to 3GPP TS 29.212, e.g. as shown below (based on 3GPP TS 29.212, version 11.3.0, December 2011, i.e. possible additions in March 2012 are not included here.)

### “Annex C (Informative):

Mapping table for type of access networks

P-GW can receive information about the access networks that are used by the UE to connect to EPS over several reference points. Table C-1 maps the values of the IANA registered Access Technology Types used for PMIP in 3GPP TS 29.275 [28] with the Values of the RAT types specified for GTPv2 in 3GPP TS 29.274 [22] and with the values of the RAT types and IP-CAN types Specified in this specification.

TABLE C-1
Mapping table for type of access network code values

| Access | | | | | | | |
|---|---|---|---|---|---|---|---|
| Technology Type | | | | | | | |
| registered with | | | | RAT-Type | | | |
| IANA, see | | PCC related | | specified for | | IP-CAN-Type, see | |
| 3GPP TS 29.275 | | RAT-Type, see | | GTPv2, see 3GPP TS | | subclause 5.3.27 | |
| [28] | | subclause 5.3.31 | | 29.274 [22] | | (NOTE 1) | |
| Value | Description | Value | Description | Value | Description | Value | Description |
| 0 | Reserved | | | 0 | <reserved> | | |
| 1 | Virtual | 1 | VIRTUAL | 7 | Virtual | 6 | Non-3GPP-EPS |
| 2 | PPP | | | | | | |
| 3 | IEEE 802.3 | | | | | | |
| 4 | IEEE | 0 | WLAN, NOTE 2 | 3 | WLAN, NOTE 2 | | |
| | 802.11a/b/g, | | | | | | |
| | NOTE 2 | | | | | | |
| 5 | IEEE | | | | | 6 | Non-3GPP-EPS |
| | 802.16e | | | | | 3 | WiMAX |
| 6 | 3GPP | 1001 | GERAN | 2 | GERAN | 0 | 3GPP-GPRS |
| | GERAN | | | | | 5 | 3GPP-EPS |
| 7 | 3GPP | 1000 | UTRAN | 1 | UTRAN | 0 | 3GPP-GPRS |
| | UTRAN | | | | | 5 | 3GPP-EPS |
| 8 | 3GPP E- | 1004 | EUTRAN | 6 | EUTRAN | 5 | 3GPP-EPS |
| | UTRAN | | | | | | |
| 9 | 3GPP2 | 2003 | EHRPD | | | 6 | Non-3GPP-EPS |
| | eHRPD | | | | | 4 | 3GPP2 |
| 10 | 3GPP2 | 2001 | HRPD | | | 6 | Non-3GPP-EPS |
| | HRPD | | | | | 4 | 3GPP2 |
| 11 | 3GPP2 | 2000 | CDMA2000_1X | | | 6 | Non-3GPP-EPS |
| | 1xRTT | | | | | 4 | 3GPP2 |
| 12 | 3GPP2 | 2002 | UMB | | | 6 | Non-3GPP-EPS |
| | UMB | | | | | 4 | 3GPP2 |
| a | Trusted | b | Trusted WLAN | c | Trusted WLAN | 6 | Non-3GPP-EPS |
| | WLAN | | | | | | |
| 13-255 | Unassigned | | | | | | |
| | | 1002 | GAN | 4 | GAN | 0 | 3GPP-GPRS |
| | | | | | | 5 | 3GPP-EPS |
| | | 1003 | HSPA_EVOLUTION | 5 | HSPA Evolution | 0 | 3GPP-GPRS |
| | | | | | | 5 | 3GPP-EPS |
| | | | | | | 1 | DOCSIS |
| | | | | | | 2 | xDSL |

NOTE 1:
The mapping of RAT-Type and Access Technology Type parameters to IP-CAN-Type depends on the packet core the radio access network is connected to. Possible mappings are listed in the IP-CAN-Type column.
NOTE 2:
The WLAN access network which has this type is not a Trusted WLAN access network.

The characters “a”, “b” and “c” added in the table above may be replaced by a specific digital number (e.g. by the 3GPP secretariat, if this solution is agreed in 3GPP).

### Example Implementation of Solution B

According to embodiments of this invention implementing solution B, a new trust relationship indication is introduced in the GTPv2 and/or PMIP S2a signalling between the TWAN and PDN-GW.

Solution B is described in the form of a Change Request to 3GPP specifications 29.275 below, too, where the new added text is shown as underlined. The trust relationship indication may be added to the Proxy Binding Update (PBU) message sent by TWAN to PDN-GW when the connection is first established. This Information Element may also be carried in the GTPv2 signalling between TWAN and PDN-GW.
3GPP TS 29.275, clause 5.1.1.1 Proxy Binding Update
. . . The Mobility Options in a PBU message for the PMIPv6 PDN Connection Creation procedure are depicted in Table 5.1.1.1-2.
. . .

TABLE 5.1.1.1-2
Mobility Options in a PBU message for the PMIPv6 PDN
Connection Creation procedure

| Information element | Cat. | IE Description | Reference |
|---|---|---|---|
| Mobile Node Identifier | M | Set to the NAI identifier of the UE as specified in 3GPP | 3GPP TS 23.003 [12] |
| option | | TS 23.003 [12]. The format of the NAI is specified in the | |
| | | subclause 19.3 in 3GPP TS 23.003 [12]. | |
| . . . | | | |
| [Other IEs not shown | | | |
| here] | | | |
| Handoff Indicator | M | Set to the value “1” to indicate attachment over a new | IETF RFC 5213 [4] |
| option | | interface. | |
| Trust Relationship | O | Contains the Trust Relationship indication option | Subclause 12.1.1.x |
| indication option | | | |
| Access Technology | M | Set to the 3GPP access type, i.e. GERAN, UTRAN or | IETF RFC 5213 [4] |
| Type option | | E-UTRAN, or to the value matching the characteristics | |
| [No need to change | | of the non-3GPP access (e.g., HRPD) the UE is using | |
| this IE in solution B.] | | to attach to the EPS as defined in the Access | |
| | | Technology Type Option type values registry of the | |
| | | IANA Mobile IPv6 Parameters Registry [18]. | |
| | | The ePDG may use the access technology type of the | |
| | | untrusted non-3GPP access network if it is able to | |
| | | acquire it; otherwise it shall indicate Virtual as the | |
| | | access technology. | |
| | | NOTE 2. | |
| | | NOTE 3. | |
| . . . | | | |

Table 5.1.1.1-2: Mobility Options in a PBU message for the PMIPv6 PDN
Connection Creation procedure

3GPP TS 29.275 Solution B CR to clause 12.1 Additional Proxy Mobile IPv6 Information Elements
12.1.1 3GPP-Specific PMIPv6 Information Elements
12.1.1.0 General
. . .
The 3GPP specific Information Elements defined by this specification are listed in the table 12.1.1.0-1.

TABLE 12.1.1.0-1
3GPP Specific PMIPv6 Information Elements

| 3GPP Specific PMIPv6 | 3GPP Specific PMIPv6 |
|---|---|
| Information Element | Information Element Description |
| Protocol Configuration | 3GPP PCO data, in the format from 3GPP |
| Options | TS 24.008 [16] subclause 10.5.6.3, |
| | starting with octet 3. |
| [several other IEs not shown | |
| here] | |
| Additional Protocol | Subclause 12.1.1.19 |
| Configuration Options | |
| Trust Relationship indication | Subclause 12.1.1.x |
| option | |

. . . (Subclause 12.1.1.x is all new text in TS 29.275 shown as underlined below for embodiments implementing solution B)
12.1.1.x Trust Relationship indication option
The purpose of the Trust Relationship indication option is to indicate whether the access network is Trusted or Untrusted, see 3GPP TS 33.402 [ . . . ] for a definition of these terms. This attribute is set by the MAG in the PBU. The LMA shall set the Trust Relationship indication option accordingly, if this option is present in the PBA.

Bits

| | | | | | | | | |
|---|---|---|---|---|---|---|---|---|
| Octets | 8 | 7 | 6 | 5 | 4 | 3 | 2 | 1 |

| | |
|---|---|
| 1 | Trust Relationship indication option |
| 2 | Trust Relationship |

FIG. 12.1.1.3-1: PMIPv6 Trust Relationship indication
The following defines the value of the PMIPv6 Trust Relationship indication.

Trust Relationship value

#1: Trusted
#2: Untrusted

The corresponding changes may also be done in 3GPP TS 29.274. If solution B is implemented in this way there is no impact on specification 3GPP TS 29.212.

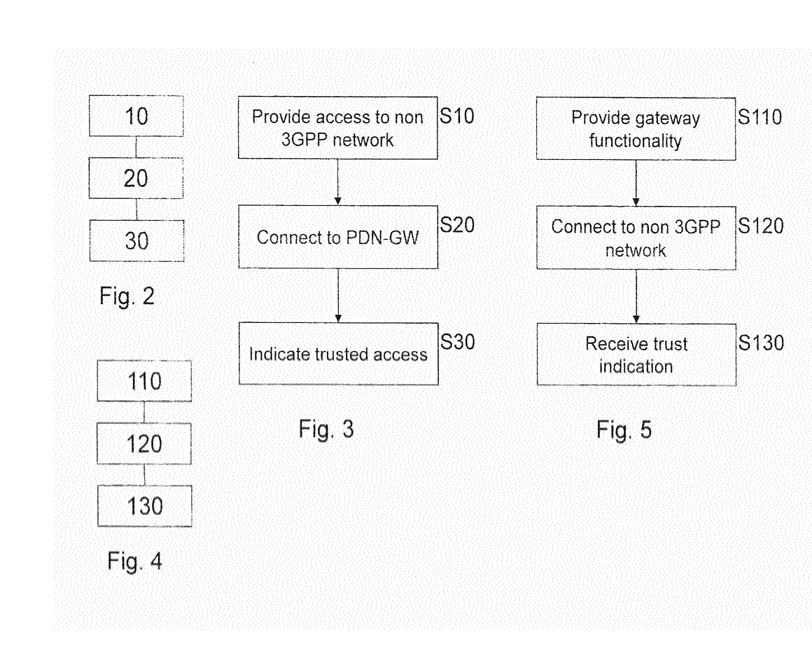

FIG. 2 shows an apparatus according to an embodiment of the invention. The apparatus may be a WLAN. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises access providing means 10, connecting means 20, and indicating means 30.

The access providing means 10 may provide non 3GPP access (e.g. WLAN access) to user equipments which may belong to a 3GPP network (S10). The connecting means 20 may connect the apparatus via an interface such as the S2a interface to a PDN-GW of a packet core network (typically a 3GPP network) (S20). The indicating means 30 may indicate to the PDN-GW via the interface that the non 3GPP network access is trusted (S30).

FIG. 4 shows an apparatus according to an embodiment of the invention. The apparatus may be a PDN-GW. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises gateway means 110, connecting means 120, and receiving means 130.

The gateway means 110 may provide a packet data network gateway functionality of a packet core network (S110). The packet core network may typically belong to a 3GPP network. The connecting means 120 may connect the apparatus via an interface to a non 3GPP access network such as a WLAN network (S120). The receiving means 130 may receive an indication from the non 3GPP network indicating whether the non 3GPP network is trusted (S130).

Embodiments of the invention are described with respect to a WLAN access network indicating that it is considered as trusted by the 3GPP operator. However, the invention is not limited to WLAN access but may be applied to any other non-3GPP access network.

A UE may be a user equipment, a terminal, a mobile phone, a laptop, a smartphone, a tablet PC, or any other device that may attach to the mobile network. A base station may be a NodeB, an eNodeB or any other base station of a radio network. If not otherwise stated or otherwise made clear from the context, the statement that two entities are different means that they are differently addressed in their respective network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a WLAN access network, or a component thereof, an apparatus embodying the same, a method for controlling and/or operating the same, and computer program(s) controlling and/or operating the same as well as mediums carrying such computer program(s) and forming computer program product(s). Furthermore, it should thus be apparent that exemplary embodiments of the present invention provide, for example a packet data network gateway, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention.

1. Apparatus, comprising access providing means adapted to provide a non 3GPP network access to a user equipment;
connecting means adapted to connect the apparatus via an interface to a packet data network gateway of a packet core network;
indicating means adapted to indicate, to the packet data network gateway via the interface, an indication whether the non 3GPP network access is a trusted access.

2. The apparatus according to claim 1, wherein the non 3GPP network access is a wireless local area network access.

3. The apparatus according to claim 1, wherein the packet core network and/or the user equipment belong to a 3GPP network.

4. The apparatus according to claim 3, further comprising an AAA interface means adapted to interface with an authentication, and/or authorization, and/or accounting server of the 3GPP network.

5. The apparatus according to claim 1, wherein the indication comprises a radio access technology type indicating whether the non 3GPP network access is a trusted access.

6. The apparatus according to claim 1, wherein the indication comprises an information element dedicated to indicating whether the non 3GPP network access is trusted.

7. The apparatus according to claim 1, wherein the indication is comprised in an additional protocol configuration option.

8. Apparatus, comprising
gateway means adapted to provide a packet data network gateway functionality of a packet core network;
connecting means adapted to connect the apparatus via an interface to a non 3GPP access network;
receiving means adapted to receive an indication from the non 3GPP network indicating whether the non 3GPP network is trusted.

9. The apparatus according to claim 8, wherein the non 3GPP access network is a wireless local area network.

10. The apparatus according to claim 8, wherein the packet core network belongs to a 3GPP network.

11. The apparatus according to claim 8, wherein the indication comprises a radio access technology type indicating whether the non 3GPP access network is trusted.

12. The apparatus according to claim 8, wherein the indication comprises an information element dedicated to indicating whether the non 3GPP access network is trusted.

13. The apparatus according to claim 8, wherein the indication is comprised in an additional protocol configuration option.

14. The apparatus according to claim 8, further comprising
charging data generating means adapted to generate charging data for a user device connected to the non 3GPP access network, wherein the charging data comprise a trust indication based on the received indication.

15. Method, comprising
providing a non 3GPP network access to a user equipment;
connecting an apparatus performing the method via an interface to a packet data network gateway of a packet core network;
indicating, to the packet data network gateway via the interface, an indication whether the non 3GPP network access is a trusted access.

16. The method according to claim 15, wherein the non 3GPP network access is a wireless local area network access.

17. The method according to claim 15, wherein the packet core network and/or the user equipment belong to a 3GPP network.

18. The method according to claim 17, further comprising interfacing with an authentication, and/or authorization, and/or accounting server of the 3GPP network.

19. The method according to claim 15, wherein the indication comprises a radio access technology type indicating whether the non 3GPP network access is a trusted access.

20. The method according to claim 15, wherein the indication comprises an information element dedicated to indicating whether the non 3GPP network access is trusted.

21. The method according to claim 15, wherein the indication is comprised in an additional protocol configuration option.

22. Method, comprising
providing a packet data network gateway functionality of a packet core network;
connecting an apparatus performing the method via an interface to a non 3GPP access network;
receiving an indication from the non 3GPP network indicating whether the non 3GPP network is trusted.

23. The method according to claim 22, wherein the non 3GPP access network is a wireless local area network.

24. The method according to claim 22, wherein the packet core network belongs to a 3GPP network.

25. The method according to claim 22, further comprising
selecting means adapted to select an IPv6 router advertisement message if the non 3GPP access network is trusted.

26. The method according to claim 22, wherein the indication comprises a radio access technology type indicating whether the non 3GPP access network is trusted.

27. The method according to claim 22, wherein the indication comprises an information element dedicated to indicating whether the non 3GPP access network is trusted.

28. The method according to claim 22, wherein the indication is comprised in an additional protocol configuration option.

29. The method according to claim 22, further comprising
generating charging data for a user device connected to the non 3GPP access network, wherein the charging data comprise a trust indication based on the received indication.

30. A computer program product including a program comprising software code portions being arranged, when run on a processor of an apparatus, to perform the method according to claim 15.

31. The computer program product according to claim 30, wherein the computer program product comprises a computer-readable medium on which the software code portions are stored, and/or wherein the program is directly loadable into a memory of the processor.
